(19) United States
(12) Patent Application Publication
(10) Pub. No.: US 2026/0009992 A1
(43) Pub. Date: Jan. 8, 2026

(54) SPLIT ILLUMINATION SYSTEM

(71) Applicant: Applied Materials Israel Ltd., Rehovot (IL)

(72) Inventors: Ron NAFTALI, Shoham (IL); Haim FELDMAN, Nof Ayalon (IL); Boris GOLBERG, Ashdod (IL); Ram ORON, Ness Ziona (IL); Itay LANGSTADTER, Kibbutz Nir Eliyahu (IL)

(21) Appl. No.: 19/261,825

(22) Filed: Jul. 7, 2025

(30) Foreign Application Priority Data
Jul. 8, 2024 (IL) 314177

(51) Int. Cl. G02B 21/08

(52) U.S. Cl. CPC G02B 21/08

(57) ABSTRACT

An optical system is described. The optical system comprises an input pupil for input of illumination radiation, and first and second field splitting stages. The first field splitting stage is configured to divide input illumination radiation into a first selected number of illumination beams along a selected first axis. The second field splitting stage is configured for receiving the first selected number of illumination beams and dividing said first selected number of illumination beam into a second selected number of illumination beams along a selected second axis. The optical system thus provides a selected number of illumination beams exiting through said output pupil and providing illumination of a region of a selected spatial shape.

### RELATED APPLICATIONS

This application claims the benefit of priority from Israeli Patent Application No. 314177, filed Jul. 8, 2024, which is incorporated herein by reference.

### TECHNOLOGICAL FIELD

The present disclosure relates to system and method for field illumination, and relates specifically to field illumination with split and/or adjustable field of view.

### BACKGROUND

Various inspection techniques utilize illumination of a selected region and collection of light reflected and/or scattered from the selected region. Optimization of inspection may be associated with various parameters including for example, improvement of illumination conditions or of the imaging arrangement.

### GENERAL DESCRIPTION

Alignment of illumination and/or collection conditions is often used for optimizing inspection. The present disclosure provides an optical arrangement and/or an inspection system. The optical arrangement is configured to provide illumination of a selected number of regions to be inspected, while adjusting shape and size of illumination region to the desired sample and collection/imaging conditions.

Generally, typical light sources and illumination systems are configured to provide illumination of a field of a selected geometrical/spatial shape. In systems that utilize illumination of a selected region, and operating with generally low spatial coherent illumination, the input illumination field may be pre-treated to reduce spatial coherence, providing a selected, typically square geometrical structure of the illumination region. This provides efficient illumination of generally square regions. On the other hand, typical light detector arrays are manufactured with a generally rectangular geometry.

Accordingly, the present disclosure provides an optical system configured for tailoring structure of illumination field to provide illumination of a selected number of regions. The optical system is generally configured to receive input illumination field through an input aperture thereof, and provide output illumination field having a selected number of illumination regions and having selected geometrical shape and size. This configuration enables efficient illumination of a plurality of regions on a sample, and simultaneous collection of light returning from the sample by an arrangement of selected number of detectors. This configuration enables alignment of detector field of view with illuminated region, providing that light substantially does not impinge on regions that are not associated with collection of returning light.

The optical system of the present disclosure comprises at least first and second light splitting stages for receiving input illumination field and divide the input illumination field to a selected number of illumination regions. The first field splitting stage is configured to divide the input illumination field to a selected number of sub-regions along a first axis, and optionally, to laterally shift the number of illumination sub-regions with respect to each other along a second axis, perpendicular to the first axis. The second field splitting stage is configured to generate a selected number of field duplications along a selected axis (being parallel to the first or second axis). The first and second axes are generally transvers/perpendicular to the optical axis of the system and may be orthogonal between them.

Generally, the optical system may include an optical arrangement comprising one or more lens units. The optical arrangement may operate as an optical relay and may define at least first and second optical planes each conjugated to at least one of input pupil of the optical system and illumination region on the sample. The first field splitting stage may be positioned at an optical plane conjugated to the sample (illumination plane) and the second field splitting stage may be positioned at an optical plane conjugated to the input pupil of the system.

Thus, according to some embodiments, the present disclosure provides the following example embodiments:

1. An optical system comprising an input pupil for input of illumination radiation, a first field splitting stage configured to divide input illumination radiation into a first selected number of illumination beams along a selected first axis, and a second field splitting stage configured for receiving said first selected number of illumination beams and dividing said first selected number of illumination beam into a second selected number of illumination beams along a selected second axis, providing a selected number of illumination beams exiting through said output pupil and providing illumination of a selected number of regions of one or more selected spatial shapes.

2. The optical system of embodiment 1, further comprising an optical arrangement comprising one or more lenses and defining at least first and second optical planes each conjugated to at least one of the input pupil and region to be illuminated, and wherein said first and second field splitting stages are positioned in said at least first and second optical planes.

3. The optical system of embodiment 1 or 2, wherein said first field splitting stage comprises a selected number of two or more optical elements stacked along a first axis perpendicular to direction of radiation propagation and configured to split input radiation into a first selected number of illumination beam along said first axis.

4. The optical system of embodiment 3, wherein said first field splitting stage is configured to apply selected lateral shifts to said first selected number of illumination beams, wherein said selected lateral shifts extend along a second axis perpendicular to said first axis and to direction of radiation propagation.

5. The optical system of embodiment 3 or 4, wherein said selected number of two or more optical elements comprise a selected number of transparent plates positioned with selected angular shifts with respect to direction of radiation propagation.

6. The optical system of embodiment 3 or 4, wherein said selected number of two or more optical elements comprise a selected number of periscope units positioned for shifting radiation beam portion laterally in two or more different lateral shifts.

7. The optical system of embodiment 3 or 4, wherein said selected number of two or more optical elements comprise a selected number of grating units having selected grating patters for shifting radiation beam portion laterally in two or more different lateral shifts.

8. The optical system of embodiment 3 or 4, wherein said selected number of two or more optical elements comprise a selected number of transparent wedge units positioned with selected angular shifts with respect to direction of radiation propagation.

9. The optical system of any one of embodiments 1 to 8, wherein said second field splitting stage comprises a diffractive grating configured for generating a selected number of multiplications of received field with respective angular directions, thereby generating a selected number of duplications of a selected illumination pattern.

10. The optical system of embodiment 9, wherein said diffractive grating is a Dammann grating.

11. The optical system of any one of embodiments 1 to 10, configured for illuminating a selected number of regions having a rectangular shape.

12. The optical system of any one of embodiments 1 to 10, configured for illuminating a selected number of regions having a non-square geometry.

13. An optical system comprising an optical arrangement defining at least first plane conjugated with a region to be illuminated and at least a second plane conjugated with an input pupil of the optical system, a first field splitting stage located at said first plane and comprising two or more light diverting elements arranged along a first axis and configured to divert light component along a second axis perpendicular to said first axis, and a second field splitting stage positioned at said second plane and configured for generating a selected number of duplicates of received field, thereby providing illumination of a selected number of regions of one or more selected spatial shapes.

14. An inspection system comprising an illumination path, one or more collection paths and a sample mount configured for holding a sample to be inspected; said illumination path comprises an optical arrangement comprising an input pupil and output pupil for input of illumination radiation, a first field splitting stage configured to divide input illumination radiation into a first selected number of illumination beams along a selected first axis, and a second field splitting stage configured for receiving said first selected number of illumination beams and dividing said first selected number of illumination beam into a second selected number of illumination beams along a selected second axis, providing a selected number of illumination beams exiting through said output pupil and provide illumination of a selected number of regions of said sample having one or more selected shapes; and said collection path comprises one or more light collection arrangement configured for collecting radiation from said selected number of regions of said sample toward one or more detector.

15. The inspection system of embodiment 14, wherein said optical arrangement further comprising an optical arrangement comprising one or more lenses and defining at least first and second optical planes each conjugated to at least one of the input pupil and region to be illuminated, and wherein said first and second field splitting stages are positioned in said at least first and second optical planes.

16. The inspection system of embodiment 14 or 15, wherein said first field splitting stage comprises a selected number of two or more optical elements stacked along a first axis perpendicular to direction of radiation propagation and configured to split input radiation into a first selected number of illumination beam along said first axis.

17. The inspection system of embodiment 16, wherein said first field splitting stage is configured to apply selected lateral shifts to said first selected number of illumination beams, wherein said selected lateral shifts extend along a second axis perpendicular to said first axis and to direction of radiation propagation.

18. The inspection system of embodiment 16 or 17, wherein said selected number of two or more optical elements comprise a selected number of transparent plates positioned with selected angular shifts with respect to direction of radiation propagation.

The inspection system of any one of embodiments 14 to 18, wherein said second field splitting stage comprises a diffractive grating configured for generating a selected number of multiplications of received field with respective angular directions, thereby generating a selected number of duplications of a selected illumination pattern.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a standard illumination layout for illuminating a target;

FIG. 2 exemplifies an illumination layout according to some embodiments of the present disclosure;

FIGS. 3A to 3C exemplify structure and operation of the first field splitting stage, FIG. 3A exemplifies input beam falling on the first field splitting stage, FIG. 3B shows a top view of first field splitting stage according to some embodiments, and FIG. 3C exemplifies shapes of illumination fields formed by operation of the first field splitting stage;

FIGS. 4A to 4C exemplify an additional structure and operation of the first field splitting stage, FIG. 4A exemplifies input beam falling on the first field splitting stage, FIG. 4B shows a top view of first field splitting stage according to some embodiments, and FIG. 4C exemplifies shapes of illumination fields formed by operation of the first field splitting stage;

FIGS. 5A to 5C exemplify additional configuration of the first field splitting stage, FIG. 5A exemplifies the use of periscope structure, FIG. 5B exemplifies the use of prism or wedge structure, and FIG. 5C exemplifies the sue of diffractive gratings;

FIG. 6 exemplifies operation of a diffractive element used as second field splitting stage; and

FIG. 7 illustrates an optical inspection system according to some embodiments of the present disclosure.

### DETAILED DESCRIPTION OF EMBODIMENTS

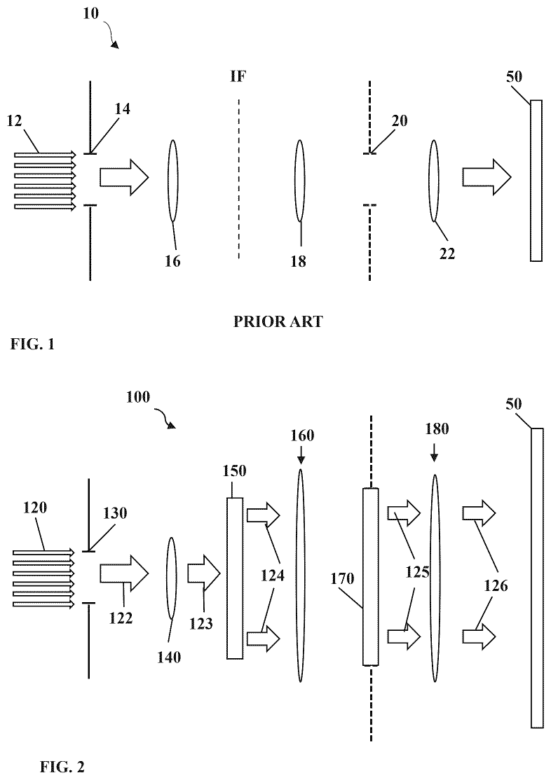

As indicated above, typical inspection of selected items may utilize providing a selected illumination of the object. FIG. 1 exemplifies a general illumination layout 10 for illuminating a sample 50. Following illumination of the sample 50, light components being reflected and/or scattered from the sample 50 are collected using a collection arrangement (not shown) to provide inspection of selected properties of the sample.

As exemplified in FIG. 1, an input illumination 12, typically provided by a light source arrangement, enters the illumination path via first aperture 14, providing initial illumination structure. The illumination layout may also include one or more lens arrangements, e.g., lens arrangements 16, 18 are illustrated, and may include an objective lens 22 or other lens arrangement, such as a condenser lens arrangement, in accordance with required optical properties for illumination. Generally, the first lens arrangement 16 directs illumination forming an intermediate (e.g., Fourier) plane IF, and the second lens arrangement 18 is located a selected distance from the intermediate plane IF directing light toward the objecting (third) lens 22. The illumination layout may include an intermediate aperture 20.

The illumination layout exemplified in FIG. 1 may provide selected illumination properties for various objects 50, while supporting limited shape and structure of the illuminated region. To this end, the present disclosure provides an optical, illumination, system configured to provide tailored illumination field. More specifically, the optical system of the present disclosure is adapted for illumination of regions having shape and structure that may be irregular, and/or to provide large field illumination, using input light having typical shape.

Reference is made to FIG. 2 exemplifying an optical system 100 for illumination of an object 50. Optical system 100 is configures to receive input illumination beam 120 through an input pupil 130, and to provide output illumination of a selected object 50.

The optical system includes at least a first field splitting stage 150 (also referred to as first splitting stage) configured to split the input illumination to a selected number of illumination beams 124. Generally, the first field splitting stage 150 divides illumination beam 123 (following lens 140) to a selected number of illumination beams 124 along a first axis. The optical system 100 further includes a second splitting stage 170, configured to receive a plurality of illumination beams 124 and to divide the selected number of illumination beams 125 to a further number of illumination beams 126, separated along a second selected axis. Generally, the first splitting stage 150 may be formed of a selected number of two or more optical elements. The optical elements of the first splitting stage 150 are stacked one on top of the other (or with spaced between them, e.g., in embodiments where free space propagation is used) along a first axis perpendicular to direction of radiation propagation. The first splitting stage is thus configured to split the radiation 123 into a first selected number of illumination beams 124 separated between them along the first axis. The output beam portions 124 exit the first splitting stage 150 with certain selected lateral shifts between them. In some embodiments, as described herein below, output beam portions 124 of the first splitting stage 150 may be separated along an axis perpendicular to the first axis defined by arrangement of the elements of the first splitting stage 150, and perpendicular to direction of propagation of radiation through the optical system. Generally, the first and second axes are transvers/perpendicular to the optical axis of the system and may be orthogonal between them.

Optical system 100 may also include one or more lenses or lens arrangements 140, 160 and 180 positioned in selected locations. In some embodiments, lens 140 may be positioned to focus beam 122 and to direct beam 123 onto first field splitting stage 150 (typically located at Fourier Plane with respect to input pupil 130). Additionally, lens arrangement 160, e.g., including one or more lenses, is positioned to image input aperture 130 (in combination with lens 140) onto second splitting stage 170 providing beam components 125 input into the second splitting stage 170. Further, lens arrangement 180, positioned for focusing the illumination beams onto the object 50.

In some configurations, the first splitting stage 150 may be located at Fourier plane with respect to lens 140. Additionally, the second splitting stage 170 may be positioned at an optical plane conjugated to input pupil 130. Generally, first splitting stage 150 may be configured for splitting illumination beam into two or more beam components separated along a first axis. Additionally, second splitting stage 170 may be configured to received two or more beam components (e.g., arriving at different angles) and to split the two or more beam components into a selected number of beam components 126, being separated along a second axis, typically perpendicular to the first axis. The term perpendicular generally relates to the first and second axes having angular relation of 90°, however, in accordance with system design, in some embodiments the relative angle may be anything between 45° and 125°.

Optical system 100 is configured to manipulate spatial structure of input illumination beam 120 to provide illumination of a selected region of an object 50, where the dimension and shape of the region may vary. The optical system 100 may be adjusted to provide relatively uniform flood illumination of the object 50 to enable various inspection processes.

As illustrated in FIGS. 2, the optical system 100 may generally include one or more lenses or lens units 140 and 160. The lens units 140 and 160 relay input pupil 130 onto a selected plane, typically where second splitting stage 170 is located, and define at least first and second optical planes, each conjugated to at least one of the input pupil 130 and the sample region 50 to be illuminated. Additionally, one or more objective/condenser lenses 180 may be used for directing the illumination beam components onto surface of the object 50.

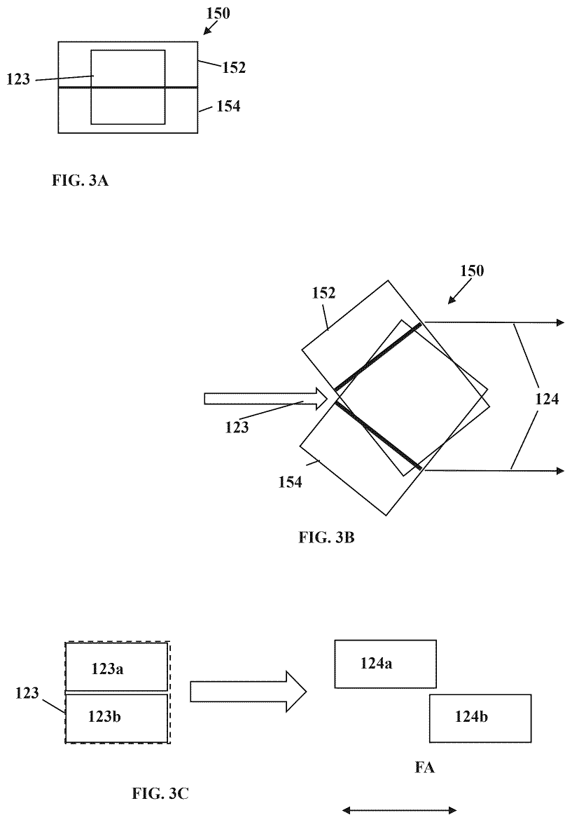

Reference is made to FIGS. 3A to 3C exemplifying a configuration of the first splitting stage 150, and beam components used as input and output of the first splitting stage 150. FIG. 3A shows first splitting stage 150 and illumination beam 123 impinging thereon, FIG. 3B shows a top view of first splitting stage 150 and exemplifies separation of illumination beam components 124 downstream of the first splitting stage 150, and FIG. 3C exemplifies splitting of region that can be illuminated by beam 123 into regions that can be illuminated by beam components 124.

Typically, input pupil 130 may have any selected shape, and may often be circular.

Further, to provide aerial illumination of the target 50, input illumination 120 may include selected spatial frequencies, providing that beam 123, generates a rectangular or square beam cross section at the Fourier plane. It should however be noted that the cross section profile of the beam may be any selected cross section that fits the specific applications for which the optical system 100 is used.

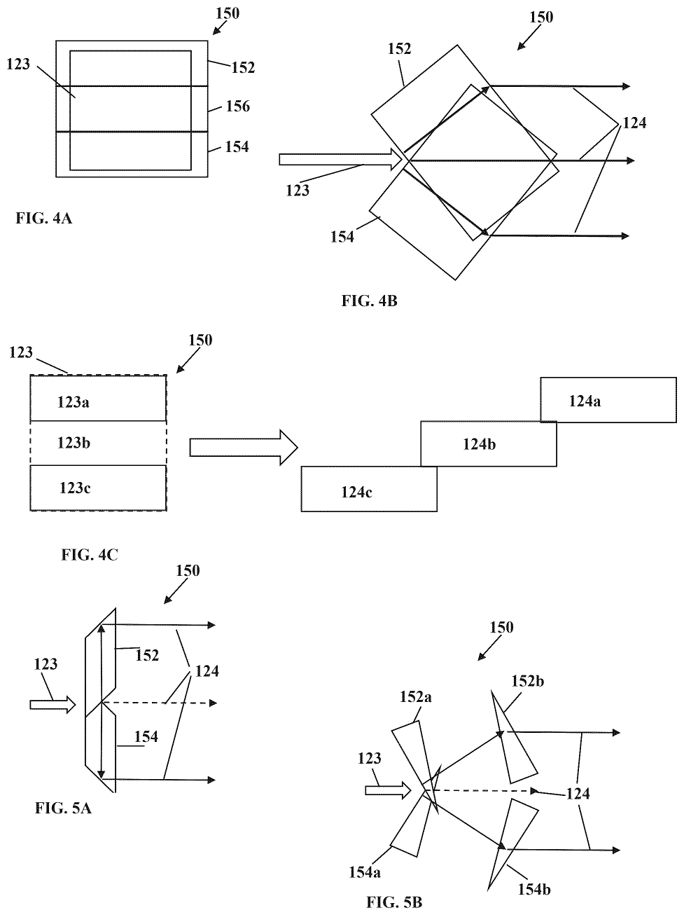

As illustrated, the first splitting stage 150 may be formed of two or more optically transparent blocks or slabs positioned one on top of the others, or one next to the others, at selected angular tilts between them. More specifically, first splitting stage 150 is illustrated in FIGS. 3A and 4B by first and second transparent blocks 152 and 154 placed one on top of the other at selected different angles. Illumination beam 122 is directed to fall on both blocks 152 and 154 such that a first portion of the beam propagated through one block and a second portion propagated through another block. As a result of the different angles of blocks 152 and 154, beam components passing therethrough are laterally shifted, resulting in output beam components 124 being separated between them along a first axis by a selected distance, while being generally shifted along a second additional axis. FIG. 3C exemplify the effect of first splitting stage 150 on illumination field generated by beam 123. As shown, beam 123 has a generally square shape, although any other shape may be used. When split by the first splitting stage 150, the beam 123 is divided into first and second beam portions 123a and 123b. As illustrated in FIG. 3B, the first splitting stage 150 separates the beam portions along a selected axis, providing first and second illumination fields 124a and 124b being spatially separated along the first axis FA.

Further, in some embodiments, the first splitting stage 150 may be configured to split the illumination beam 123 into a selected number of beam portion, being two or more beam portions. For example, FIGS. 4A to 4C exemplify a first splitting stage 150 configured for splitting an input illumination beam 123 into three beam portions. FIG. 4A illustrate a side view of the first splitting stage 150, showing three layers of optically transparent plates, or material blocks 152, 154 and 156. FIG. 4B shows a top view of the first splitting stage 150 showing that material blocks 152 and 154 are positioned at an angle relative to propagation path of input beam 122, while material block 156 may be positioned at normal angle (perpendicular) to propagation path of input beam 122, or being a free space propagation path, e.g., a gap between material blocks 152 and 154. FIG. 4C exemplify splitting of the illumination field formed by beam 123 into three spatially separated illumination fields 124a, 124b and 124c. Generally, optically transparent material blocks 152, 154 and 156, are made of material transparent to radiation of wavelength range selected in accordance with wavelength range used by the optical system 100, being optical radiation, Infrared, Ultraviolet etc.

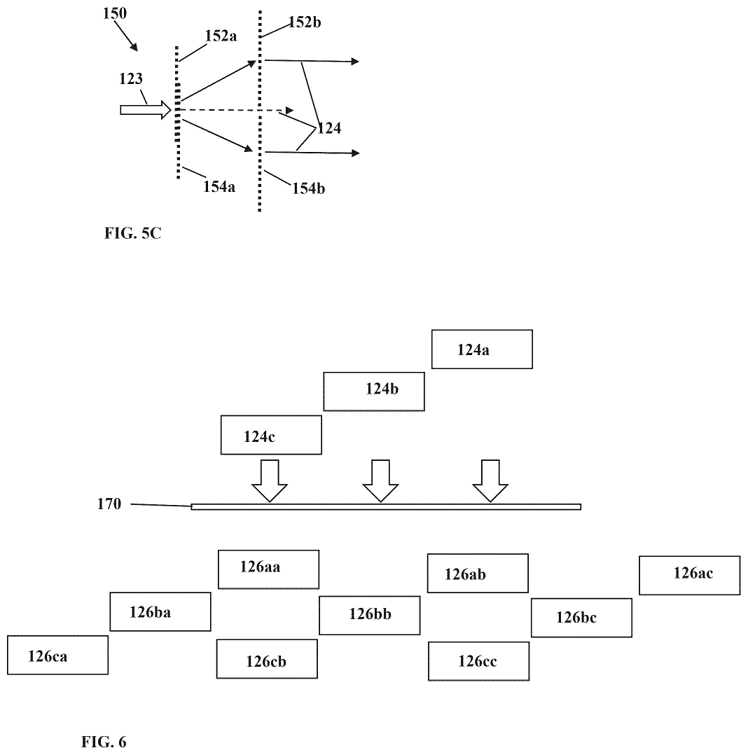

Furthermore, FIGS. 5A to 5C exemplify additional possible configurations of the first splitting stage 150 according to certain embodiments of the present disclosure. FIG. 5A exemplifies a configuration utilizing a periscope shape of the block materials 152 and 154. The block elements are positioned and aligned to shift first and second portion of input beam 123 laterally. This configuration can provide two or more output beam portions 124, for example, selected different lengths of the periscope structures may be used to determine spatial shift of the beam portions. FIG. 5B exemplifies a configuration of the first splitting stage 150 using an arrangement of prisms or wedge units 152a, 152b, 154a and 154b, positioned to split input beam 123 into two or three output beam portions 124. The wedge units 152a, 152b, 154a and 154b are generally placed and positioned to generate a first angular shift to beam portions and align output beam portions 124 to direction of propagation of radiation through the system.

Further, FIG. 5C exemplifies configuration of the first splitting stage 150 utilizing grating arrangements 152a, 152b, 154a and 154b, positioned and configured to split the input beam 122 into two or three beam portions 124.

Generally, grating elements 152a and 154a are separated between them in an axis perpendicular to direction of propagation of radiation beam 123, as exemplified in FIGS. 3A and 4A. The pattern of the grating elements 152a, 154a is selected to cause selected angular variation to direction of propagation of beam 123. Additionally, the pattern of grating elements 152b and 154b is selected to align output beam portions 124 along a desired direction of propagation through the system 100.

As illustrated above, with reference to FIGS. 3A and 4A, the beam splitting elements 152 and 152, being configured from transparent material blocks, wedges, and/or grating elements, are preferably placed in a selected order along an axis perpendicular to direction of propagation of input beam 123, such that different portions of the input beam 123 fall on different elements 152, 154 (and optionally 156 as exemplified in FIG. 4A) and is thus split into two or three portions.

As described above, beam portions 124 may propagate through the optical system and are generally further split by the second splitting stage 170. FIG. 6 schematically illustrates operation of the second splitting stage 170 according to some embodiments of the present disclosure. Typically, beam portions 124 may be parallel and spatially separated, while lens arrangement 160 may manipulate beam portion propagations and varying angular direction as a function of spatial location of the beams. Accordingly, beam portions 125 may reach the second splitting stage at different angles. The second splitting stage 170 may include at least one diffractive element, e.g., Dammann grating, configured for splitting an input beam components 125 into a selected number of beam portions 126, having generally similar intensity. The split beam portions may exit the second splitting stage at selected angles, determined in accordance with diffractive pattern of the diffractive elements. FIG. 6 illustrates three beam portions 125a, 125b and 125c, resulting of the first splitting stage 150 and lens arrangement 160 and entering the second splitting stage 170. The diffractive grating of second splitting stage 170 splits each of the beam components into a selected second number of beam components, separated along a selected axis, generally being perpendicular to first axis defined by the first splitting stage 150.

Generally, the optical system of the present disclosure may utilize one or more optical lenses, such as lend arrangements 140, 160 and 180 illustrated in FIG. 2 above, for manipulating input beam. The optical manipulation may relate to translation between lateral shifts and angular direction of beam components and vice versa. For example, in some embodiments, first splitting stage 150 may introduce lateral shift of beam components as exemplified above. This lateral shift is translated to beam components having different angular directions within a first plane (the first plane is defined as a plane formed by the optical axis of the system and the first axis defined by the first splitting stage). FIG. 6 exemplifies the second splitting stage 170, where beam components 124a-124c arrive having different angular directions within a plane perpendicular to the sheet.

The second splitting stage 170 operates to split the beam components along a second axis perpendicular to the first axis, which in this example is within a plane of the sheet.

Condenser lens 180 may thus be used to translate the angular variation of beam components 126aa-126cc exemplifying in FIG. 6 to respective regions of the target object 50.

In accordance with optical design of the optical system 100, output beam portions 126 of the second splitting stage 170 may be multiplications of beam portions 125, propagating with varied angular directions about a second axis. Thus, using the first 150 and second 170 splitting stages, the optical system 100 provides for splitting an input illumination field into a number of field portion duplications having selected spatial arrangement between them. Typically, output beam portions 126 may be rectangular, however selected variation may be applied using angular orientations of the optical elements to provide periodogram structure of the output beam portions 126. Generally, based on configuration of the first splitting stage 150, the shape of output beam portions 126 may have a non-square geometry.

Output beam components exiting the second splitting stage 170 are formed of a number of output beams, arranged in accordance with arrangement of the output beams of the first splitting stage 150. FIG. 6 exemplifies splitting of three beam components 125a, 125b and 125c, into nine beam components marked as 126aa, 126ab, 126ab, 126ba, 126bb, 126bc, 126ca, 126cb, and 126cc. As indicated above, generally, beam components 125 reach the second splitting stage at different angles about the first axis, each of the beam components is split into selected number of beam components having different angle of propagation about the second axis.

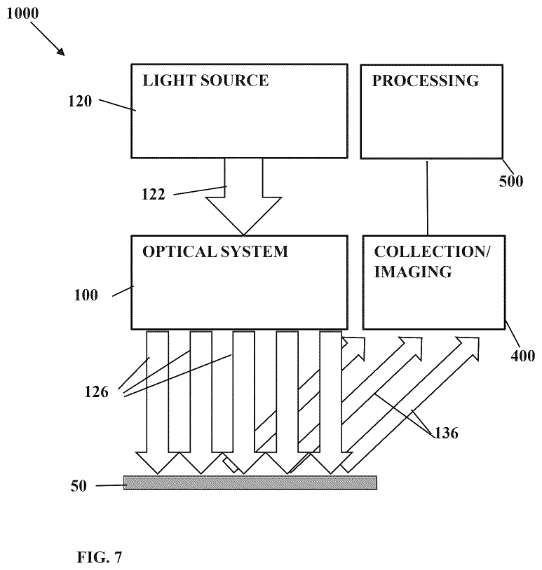

Further, reference is made to FIG. 7, exemplifying schematically an inspection system 1000 configured for optical (e.g., using visible, infrared, ultraviolet or X-ray wavelength ranges) inspection of a sample 50. The system 1000 includes a light source 120 configured to provide illumination beam 122, optical system 100 configured as described herein above for splitting and aligning beam 122 to provide a selected arrangement of beam portions 127 for illuminating selected regions of the sample 50.

Inspection system 1000 may also include collection/imaging arrangement 400 configured for collecting radiation 137 reflected and/or scattered from the sample 50 and may also include processing unit 500 for receiving and processing data about the reflected/scattered radiation, and for determining one or more parameters of the sample 50.

As indicated above, optical system 100 may include an input pupil and an output pupil for input/output of illumination radiation. Additionally, optical system 100 includes a first field splitting stage configured to divide input illumination radiation into a first selected number of illumination beams along a selected first axis. Further, optical system 100 also includes a second field splitting stage configured for receiving said first selected number of illumination beams and dividing said first selected number of illumination beam into a second selected number of illumination beams along a selected second axis.

As indicated above, the optical system provides a selected number of illumination beams exiting through said output pupil for illuminating a selected number of regions of the sample 50.

The collection/imaging arrangement defines a collection path for collecting light/radiation 136 reflected or scattered from the sample 50. The collection/imaging 400 may include one or more optical elements for collecting radiation from the selected number of regions of the sample 50 and direct the collected light onto one or more detectors.

As indicated above, the optical system 100 may include one or more lenses defining at least first and second optical planes. The at least first and second optical planes include at least one optical plane conjugated with input pupil of the optical system, and at least one optical plane conjugated to the sample 50 region to be illuminated. As described above, the first and second field splitting stages are positions within the first and second optical planes. Generally, the optical system 100 may be configured in accordance with the above-described configuration and various embodiments.

Accordingly, the present disclosure provides an optical system suitable for manipulating structure of an illumination beam, enabling selected illumination conditions suitable for a general field/target/sample. The optical system enables tailoring of shape, size and arrangement of an illumination field, allowing for illumination of various shapes of regions on a sample. This configuration is highly important when inspecting a sample having a non-square geometry.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. An optical system comprising an input pupil for input of illumination radiation, a first field splitting stage configured to divide input illumination radiation into a first selected number of illumination beams along a selected first axis, and a second field splitting stage configured for receiving said first selected number of illumination beams and dividing said first selected number of illumination beam into a second selected number of illumination beams along a selected second axis, providing a selected number of illumination beams exiting through said output pupil and providing illumination of a selected number of illumination regions of one or more selected spatial shapes.

2. The optical system of claim 1, further comprising an optical arrangement comprising one or more lenses and defining at least first and second optical planes each conjugated to at least one of the input pupil and region to be illuminated, and wherein said first and second field splitting stages are positioned in said at least first and second optical planes.

3. The optical system of claim 1, wherein said first field splitting stage comprises a selected number of two or more optical elements stacked along a first axis perpendicular to direction of radiation propagation and configured to split input radiation into a first selected number of illumination beam along said first axis.

4. The optical system of claim 3, wherein said first field splitting stage is configured to apply selected lateral shifts to said first selected number of illumination beams, wherein said selected lateral shifts extend along a second axis perpendicular to said first axis and to direction of radiation propagation.

5. The optical system of claim 3, wherein said selected number of two or more optical elements comprise a selected number of transparent plates positioned with selected angular shifts with respect to direction of radiation propagation.

6. The optical system of claim 3, wherein said selected number of two or more optical elements comprise a selected number of periscope units positioned for shifting radiation beam portion laterally in two or more different lateral shifts.

7. The optical system of claim 3, wherein said selected number of two or more optical elements comprise a selected number of grating units having selected grating patters for shifting radiation beam portion laterally in two or more different lateral shifts.

8. The optical system of claim 3, wherein said selected number of two or more optical elements comprises a selected number of transparent wedge units positioned with selected angular shifts with respect to direction of radiation propagation.

9. The optical system of claim 1, wherein said second field splitting stage comprises a diffractive grating configured for generating a selected number of multiplications of received field with respective angular directions, thereby generating a selected number of duplications of a selected illumination pattern.

10. The optical system of claim 9, wherein said diffractive grating is a Dammann grating.

11. The optical system of claim 1, configured for illuminating a selected number of regions having a rectangular shape.

12. The optical system of claim 1, configured for illuminating a selected number of regions having a non-square geometry.

13. An optical system comprising an optical arrangement defining at least first plane conjugated with a region to be illuminated and at least a second plane conjugated with an input pupil of the optical system, a first field splitting stage located at said first plane and comprising two or more light diverting elements arranged along a first axis and configured to divert light component along a second axis perpendicular to said first axis, and a second field splitting stage positioned at said second plane and configured for generating a selected number of duplicates of received field, thereby providing illumination of a selected number of regions of one or more selected spatial shapes.

14. An inspection system comprising an illumination path, one or more collection paths and a sample mount configured for holding a sample to be inspected;
said illumination path comprises an optical arrangement comprising an input pupil and output pupil for input of illumination radiation, a first field splitting stage configured to divide input illumination radiation into a first selected number of illumination beams along a selected first axis, and a second field splitting stage configured for receiving said first selected number of illumination beams and dividing said first selected number of illumination beam into a second selected number of illumination beams along a selected second axis, providing a selected number of illumination beams exiting through said output pupil and provide illumination of a selected number of regions of said sample having one or more selected shapes; and
said collection path comprises one or more light collection arrangement configured for collecting radiation from said selected number of regions of said sample toward one or more detector.

15. The inspection system of claim 14, wherein said optical arrangement further comprising an optical arrangement comprising one or more lenses and defining at least first and second optical planes each conjugated to at least one of the input pupil and region to be illuminated, and wherein said first and second field splitting stages are positioned in said at least first and second optical planes.

16. The inspection system of claim 14, wherein said first field splitting stage comprises a selected number of two or more optical elements stacked along a first axis perpendicular to direction of radiation propagation and configured to split input radiation into a first selected number of illumination beam along said first axis.

17. The inspection system of claim 16, wherein said first field splitting stage is configured to apply selected lateral shifts to said first selected number of illumination beams, wherein said selected lateral shifts extend along a second axis perpendicular to said first axis and to direction of radiation propagation.

18. The inspection system of claim 16, wherein said selected number of two or more optical elements comprise a selected number of transparent plates positioned with selected angular shifts with respect to direction of radiation propagation.

19. The inspection system of claim 14, wherein said second field splitting stage comprises a diffractive grating configured for generating a selected number of multiplications of received field with respective angular directions, thereby generating a selected number of duplications of a selected illumination pattern.
